(19) United States
(12) Patent Application Publication
(10) Pub. No.: US 2024/0425070 A1
(43) Pub. Date: Dec. 26, 2024

(54) METHODS AND SYSTEMS FOR GENERATING WEATHER MAPS

(71) Applicant: Woven by Toyota, Inc., Tokyo (JP)

(72) Inventor: Edward Warner Higgins, Redmond, WA (US)

(73) Assignee: Woven by Toyota, Inc., Tokyo (JP)

(21) Appl. No.: 18/213,562

(22) Filed: Jun. 23, 2023

(51) Int. Cl. B60W 50/14; B60L 58/13; B60W 40/02

(52) U.S. Cl. CPC B60W 50/14; B60L 58/13; B60W 40/02; B60L 2240/66; B60L 2250/16; B60L 2260/52; B60W 2050/146; B60W 2555/20; B60W 2556/20

(57) ABSTRACT

Systems and methods disclosed herein include generating weather data and location data using a sensor provided on a vehicle, determining a confidence level of the weather data and the location data, compiling the weather data and the location data into a weather map by selectively integrating the weather data based on the confidence level of the weather data, and transmitting the weather map to the vehicle for display to a user of the vehicle.

### TECHNICAL FIELD

The present disclosure relates to weather detection technologies, and more particularly, to use weather detection technologies to generate weather maps.

### BACKGROUND

A weather map is a graphical representation of various weather conditions and meteorological data over a specific geographic area. It provides visual information about temperature, precipitation, wind patterns, atmospheric pressure, cloud cover, and other relevant weather parameters. The data is analyzed and plotted on the map to create a visual representation of the current or predicted weather conditions. Accurate weather data may be useful to drivers of vehicles. Therefore, a need exists for alternative systems and methods for capturing accurate weather data for use by vehicles.

### SUMMARY

In a first aspect, system including a vehicle, a sensor provided on the vehicle, where the sensor is operable to generate weather data and location data, and a processor programmed to compile the weather data and the location data into a weather map and transmit the weather map to the vehicle for display to a user of the vehicle.

In a second aspect, a method including generating weather data and location data using a sensor provided on a vehicle, determining a confidence level of the weather data and the location data, compiling the weather data and the location data into a weather map by selectively integrating the weather data based on the confidence level of the weather data, and transmitting the weather map to the vehicle for display to a user of the vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example weather mapping system, according to one or more embodiments shown and described herein;

FIG. 2 schematically depicts an example method of generating a weather map, according to one or more embodiments shown and described herein;

FIG. 3A schematically depicts an example method of generating a battery range based on a regular driving territory, according to one or more embodiments shown and described herein;

FIG. 3B schematically depicts an example method of generating a battery range based on a route, according to one or more embodiments shown and described herein;

FIG. 4 schematically depicts an interior view of an example vehicle used in the weather mapping system, according to one or more embodiments shown and described herein;

FIG. 5 schematically depicts non-limiting components of the devices on the server of the weather mapping system, according to one or more embodiments shown and described herein;

FIG. 6 schematically depicts non-limiting components of the devices on the vehicles of the weather mapping system, according to one or more embodiments shown and described herein;

FIG. 7 illustrates a flow diagram of illustrative steps for generating a weather map, according to one or more embodiments shown and described herein; and

FIG. 8 illustrates a flow diagram of illustrative steps for generating a charge range for an electric vehicle, according to one or more embodiments shown and described herein.

### DETAILED DESCRIPTION

Embodiments disclosed herein are directed to weather mapping systems and methods for generating a real-time high-fidelity weather map based on weather data collected by sensors equipped on vehicles in a network of vehicles, and also delivering the generated weather map to the vehicles in the network. A weather map in a vehicle informs a user of the vehicle about current and upcoming weather conditions. The user then can, based on the weather map, make decisions regarding route planning, emergency preparedness, time management, and outdoor activities. Particularly, a weather map may provide real-time information about weather conditions, which is useful to identify areas with heavy rain, storms, or other hazardous weather conditions. Accordingly, the user may drive alternate routes or make adjustments to ensure a preferred and more efficient journey. Even if the user does not adjust the route, by knowing the current weather condition beforehand, the user can prepare for potential undesired challenges such as fog, snow, ice, or high winds and adjust driving behaviors or take desired precautions to minimize the undesired weather-related influences.

Weather maps are usually produced by meteorological agencies and organizations that gather data from various sources, such as weather stations, satellites, radar systems, and other monitoring instruments. The precision and reliability of the weather information displayed in the maps depend on the density and distribution of such data collection equipment. Unfortunately, several areas, including many parts of the United States, lack access to advanced equipment for gathering desired weather observation data. Additionally, weather patterns can be highly unpredictable, particularly in areas with dynamic weather. To improve accuracy and reflect the current state of the weather, it is desirable to utilize real-time weather maps that incorporate the latest data from distributed weather detection technologies in the area to help drivers be informed and prepared for sudden changes in weather conditions. As a result, it would be beneficial to have vehicles equipped with sensors that can collect and share real-time weather data to create comprehensive and up-to-date weather maps.

Various embodiments of the methods and systems for generating weather maps are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

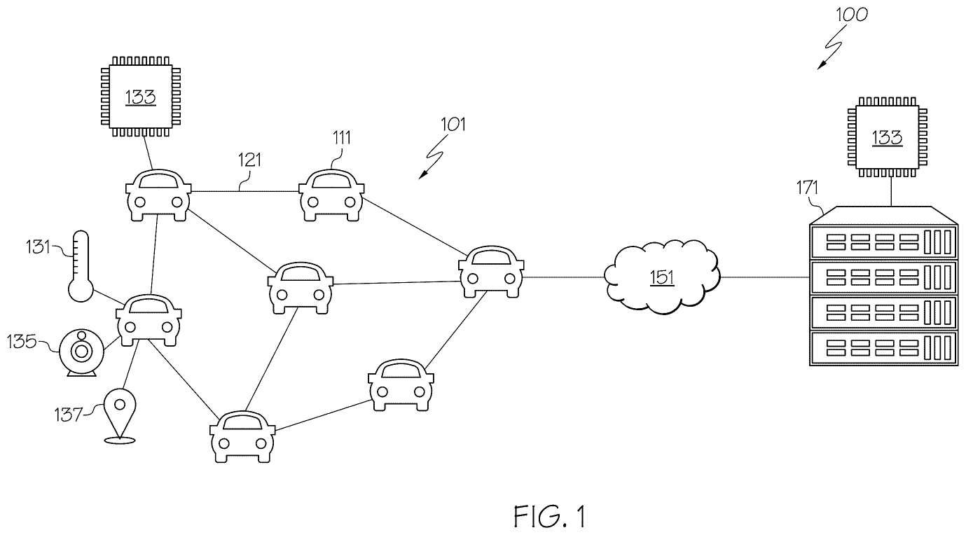

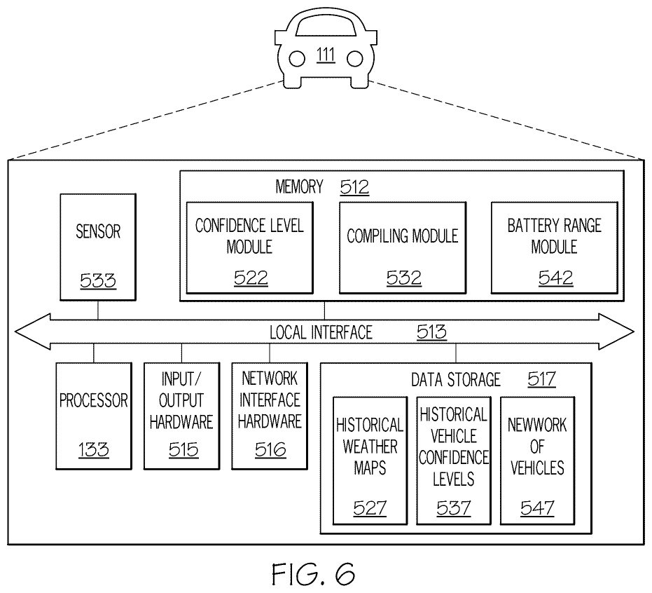

Turning to figures, FIG. 1 generally depicts one embodiment of an example weather mapping system 100. Embodiments disclosed herein are directed to a weather mapping system for generating a real-time high-fidelity weather map based on weather data collected by sensors 533 (e.g. as illustrated in FIG. 6) equipped on vehicles in a network 101 of vehicles 111.

The weather mapping system 100 includes one or more vehicles 111 and a processor 133. The one or more vehicles 111 may form a network with connections 121 between the vehicles 111. The vehicles 111 of the network 101 may equip one or more sensors 533 (e.g. as illustrated in FIG. 6), such as a temperature sensor 131, a camera 135 and/or a Global Positioning System (GPS) sensor 135, operable to generate weather data and location data. For example, some of the vehicles 111 may have onboard weather stations that include a set of instruments and sensors 533 (e.g. as illustrated in FIG. 6) designed to measure and record various meteorological parameters. The weather stations may include components to provide real-time weather data for weather monitoring while the vehicle is in motion. A weather station may include multiple sensors that are used for high-fidelity weather data collection, such as, without limitation, anemometer, barometer, thermometer, hygrometer, rain gauge, pyranometer, pyrgeometer, and altimeter. Some of the vehicles 111 may not include sensors specifically for high-fidelity weather data but may detect weather conditions, such as raining, snowing, and fog, using sensors onboard, such as cameras 135, temperature sensors 131, and ultrasonic sensors.

In embodiments, the sensors 533 (e.g. as illustrated in FIG. 6) equipped on the vehicle 111 to detect and collect weather data may include proximity sensor, a camera, a radar, a thermometer, a barometer, a hygrometer, an anemometer, an ultrasonic sensor, a pyranometer, or other weather data sensors. The vehicles 111 are also provided location sensors to collect location data of the vehicles 111 and associate the weather data with the corresponding geographical location using latitude and longitude coordinates. The weather data points may be positioned on the weather map to maintain spatial fidelity. The location sensor used on the vehicles 111 may be a GPS sensor, a compass, a global navigation satellite system (GLONASS) sensor, a Galileo system sensor, a BeiDou system sensor, or the like.

The weather data and location data may be transmitted to a server 171 or vehicles 111 in the network 101. In embodiments, the vehicles 111 of the network 101 may communicate with the server 171 through an out-of-network connection 151, such as a cloud, an internet, a cellular mobile network, WiFi, or satellite communication. The vehicles 111 of the network 101 may communicate with each other vehicle 111 through dedicated short-range communications (DSRC), such as vehicle-to-vehicle (V2V) communications and vehicle-to-infrastructure (V2I), cellular vehicle-to-everything (X-V2X), WiFi based methods, cellular networks, or Ad Hoc network.

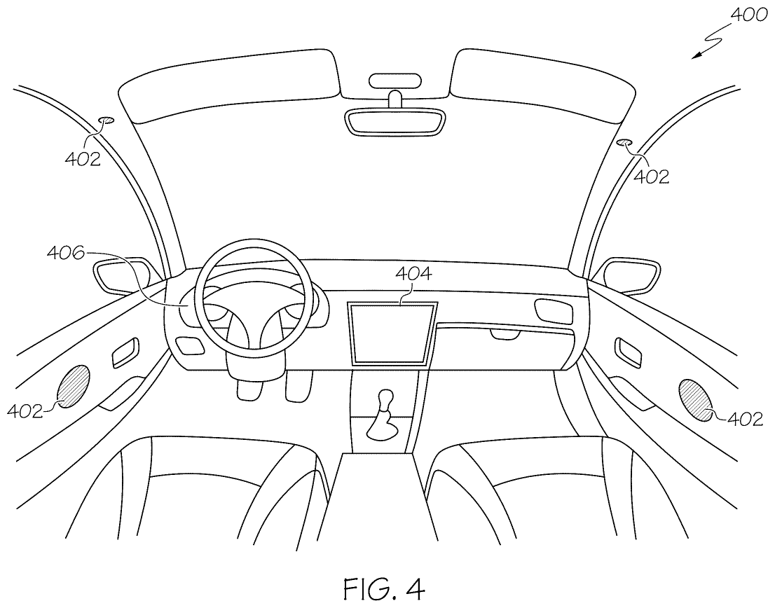

The processor 133 may be provided on the server 171 or on a vehicle 111 of the network 101. The processor 133 may be programmed to compile the weather data and the location data into a weather map. The generated weather map is then transmitted to the one or more vehicles 111 of the network 101 for display to users of the one or more vehicles (e.g. as in FIG. 4, the weather map may be displayed on the screen 404 or dashboard 406 of the vehicles 111).

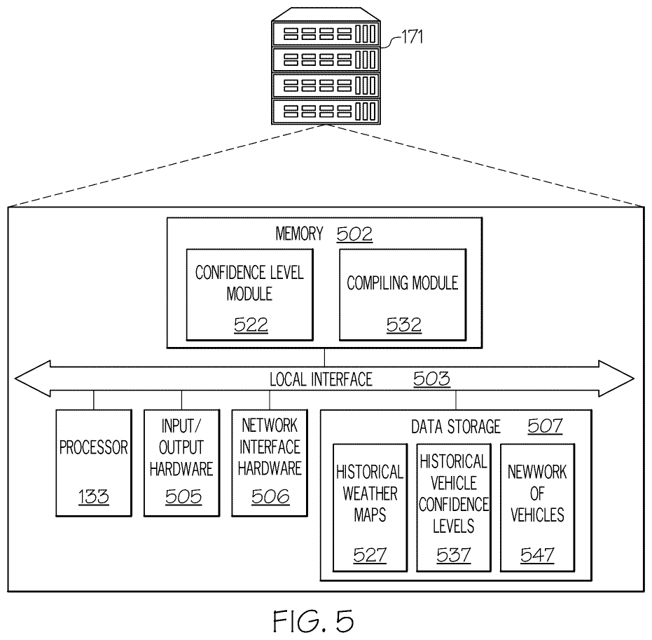

For transmission between the vehicles 111, the weather data and location data may be transmitted via the connections 121, such as V2V communication. The connections 121 allows the vehicles 111 to communicate with each other. The vehicles 111 connected to each other are neighboring nodes or neighboring vehicles. In embodiments, the communication between the vehicles 111 may follow a gossip protocol or a transmission control protocol. In a gossip protocol, a vehicle 111 communicates only to its neighboring vehicles through connections 121 to broadcast blocks or transactions. Once the vehicle 111 communicates with one of its neighboring vehicles with weather data or a weather map, the neighboring vehicle may continue to communicate with other neighboring vehicles in the same manner. In the transmission control protocol, vehicles 111 communicate with each other directly through internet or wireless networks. The information of the one or more vehicles 111, such as identification of the vehicles 111 and the connections 121 between the vehicles 111, may be saved as a network of vehicles 547 in a data storage 507 on the vehicles 111 and the server 171 (e.g. as illustrated in FIGS. 5 and 6).

In some embodiment, the weather mapping system 100 may be a decentralized system. In the decentralized system, the network 101 may not connect to the server 171. Instead, the weather mapping system 100 relies on the connections 121 between the vehicles 111 in the network 101. The vehicles 111 share the weather data and weather maps without the need for intermediaries. The network 101 and the connections 121 may employ a peer-to-peer model, such as blockchain model with each vehicle 111 as a node in the network 101, a distributed filing sharing model, a peer-to-peer messaging model, a mesh network model, or similar models. The vehicles 111 may each include a processor 133 that may compile the weather data into a weather map. The weather data may be detected by the sensors on the vehicle or is received from other vehicles 111 in the network 101. The generated weather map is further transmitted to other vehicles via the connections 121.

In some embodiment, the weather mapping system 100 may be a centralized system. In the centralized system, the vehicles 111 with sensors to detect weather data may transmit the weather data to the server 171 without transmitting to the vehicles 111 in the network. The server 171 includes one or more processors 133 and compile the received weather data into a weather map. The server 171 may transmit the generated weather map to the vehicles 111 of the network 101. A vehicle 111, upon receiving a weather map, may further transmit the weather map to other vehicles 111 of the network 101.

In some embodiments, the weather mapping system 100 may be a hybrid system of centralization and decentralization. The hybrid system may allow each vehicle to be configured to use a peer-to-peer model for weather data storage and processing, while also connecting to the server 171 for more reliable weather data and weather maps.

In the hybrid system, the vehicles 111 may communicate with each other via the connections 121 in exchanging detected weather data and transmitting selective weather data to the server 171. The selection credential for the weather data to be transmitted to the server 171 may be computational requirements, data reliability, data sensitivity, or network conditions. A selective transmission strategy balances the workload and optimizes the performance of the server 171. The processor 133 on the server 171 may compile the selective weather data into a weather map and send the weather map to the vehicles 111 of the network 101.

In the hybrid system, the vehicles 111 may transmit the weather data to the vehicles having a connection 121 or to the server 171. Both the processor 133 on the vehicles 111 and the server may use the received weather data to generate a weather map and share the weather map with the vehicles 111 in the network 101. For the vehicle 111 receiving the weather data transmitted from another vehicle 111, the vehicle 111 may use the processor 133 onboard to compile a weather map or update a weather map available on the vehicle 111 based on the received weather data. Once the server 171 sends an updated weather map, the vehicle can replace the current map with the new one. Once the server 171 sends an updated weather map, the vehicle 111 may replace the weather map generated by the vehicle 111 with the one generated by the server 171. To ensure reliability and consistency, the server 171 may periodically synchronize the weather data and weather maps back to the vehicles 111 of the network 101 at predetermined intervals, such as, not limited to, 1 second, 5 seconds, 10 seconds, 30 seconds, 1 minute, 5 minutes, 10 minutes, 15 minutes, 30 minutes, 1 hours, 2 hours, 5 hours, 10 hours, 15 hours, 20 hours, 24 hours, or any length of time between 1 second and 24 hours. By keeping the vehicles 111 updated with the latest weather maps, the vehicles 111 may have access to reliable information. In this way, the vehicles 111 can benefit from the speed and agility of the peer-to-peer model, while also having access to the security and reliability of the server 171.

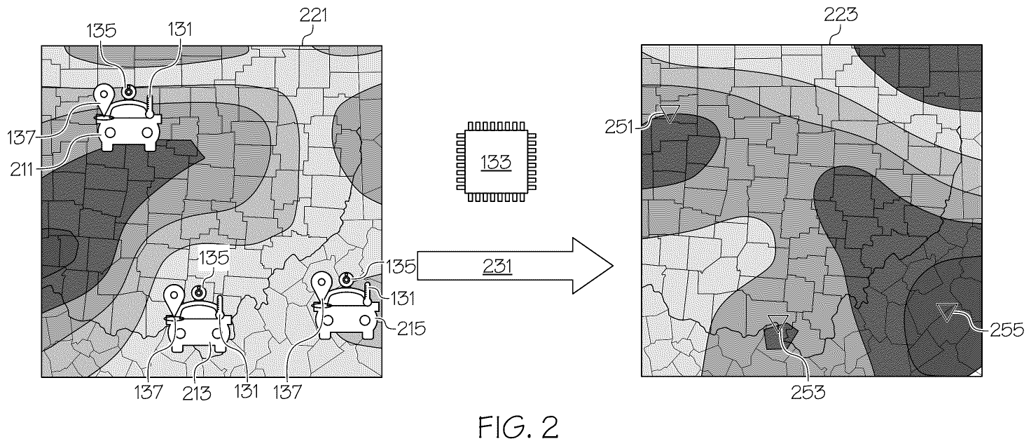

Referring to FIG. 2, an example method of generating a weather map is depicted. Three vehicles 211, 213, and 215 at different locations may detect weather data, such as temperature and wind speed, and weather conditions, such as snow and rain, with the sensors onboard, such as temperature sensors 131 and cameras 135. The vehicles 211, 213, 215 at different locations may also detect the location data using the GPS sensors 137. The processor 133 on the vehicles 111 or the server 171 (e.g. as illustrated in FIG. 1) may receive weather data and location data transmitted from the vehicles 211, 213, and 215 and compile 231 the weather data according to the location of the weather data into a real-time weather map 223. The real-time weather map 223 may mark locations, such as locations 251, 253, and 255, of the weather data source. The weather map may represent one of the weather variables detected by the sensors, such as temperature. The weather map may be plotted in a plotting type that is user-friendly and in a desired format to be apprehended by the users of the vehicles 111 (e.g., as illustrated in FIG. 1), such as display on the screens (e.g. the dashboard 406 and screen 404 as illustrated in FIG. 4) in the vehicles. The weather map may be plotted as, without limitation, a gradient map, a cluster map, a choropleth map, contour map, or a heatmap.

The weather map may also include severe weather conditions, such as heavy rain, snowfall, fog, hailstorms, strong winds, thunderstorms, flooding, freezing rain, tornadoes freezing temperature, and the like. The severe weather conditions may be detected using various sensors, such as cameras, proximity sensors, humidity sensor, ultrasonic sensors, or the like. The severe weather conditions may be determined based on the weather data and the location data. For example, heavy rainfall may be detected facilitated through rain sensors on the windshield or by monitoring the frequency and intensity of raindrops hitting the vehicle. Fog may be detected using light sensor of low visibility. Snow or ice may be detected using a proximity sensor or a temperature sensor, in cooperating with other onboard systems like advanced driver assistance systems (ADAS) or autonomous driving features. The processor 133 may integrate the severe weather condition into the weather map after determining the severe weather condition exists.

In some embodiments, the processor 133 may access a retrieved weather map 221 from the historical weather maps 527 (e.g. as illustrated in FIGS. 5 and 6), and compile 231 the weather data into the retrieved weather map 221 to generate a real-time weather map 223. The processor 133 may replace the retrieved weather data at a location with newly reported weather data and update the weather map accordingly.

In some embodiments, the processor 133 may generate a high-fidelity weather map using external weather data from reliable external sources other than the vehicles 111 in the network 101 (e.g. as illustrated in FIG. 1). Such external sources, such as meteorological agencies, research institutions, or specialized weather data providers, may provide detailed and accurate information. The processor 133 then compile 231 the weather data into the retrieved weather map 221 to generate a real-time weather map 223. The processor 133 may replace the external weather data at a location with newly reported weather data and update the high-fidelity weather map accordingly.

After vehicles 111 having collected weather data and location data using various sensors, the vehicles 111 transmit the weather data and location data to the processor 133. For example, as illustrated in FIG. 2, vehicles 211, 213, and 215 reported temperature data detected using temperature sensors 131 equipped on the vehicles 211, 213, and 215. The vehicles 211, 213, and 215 may transmit other weather data and weather conditions with other sensors, such as a camera 135, and report them to the processor 133.

Once the processor 133 receives the weather data and location data, the processor 133 may compile 231 the temperature data and location data into a weather map using a compiling module 532 (as illustrated in FIGS. 5 and 6). The processor 133 may first preprocess the weather data to enhance the accuracy and reliability of the data using a confidence level module 522 (e.g. as illustrated in FIGS. 5 and 6). To preprocess the weather data, the processor 133 is operable to determine a confidence level of the weather data and the location data, and label the weather data as high-fidelity weather data when the confidence level is beyond a threshold value and as low-fidelity weather data when the confidence level is less than or equal to the threshold value.

The confidence level may be determined based on the historical weather data maps retrieved from the historical weather maps 527 (e.g. as illustrated in FIGS. 5 and 6). The processor 133 may access the patterns, consistency, and accuracy in the weather data over time to evaluate if there may exist any biases, inconsistencies, or anomalies that may affect its reliability. Consistent and accurate historical weather data increases confidence in the reported weather data.

The confidence level may also be determined based on the confidence level of the reported vehicle, which is retrieved from the historical vehicle confidence levels 537 (e.g. as illustrated in FIGS. 5 and 6). A vehicle confidence level may be based on the accuracy of the historical weather data reported by the vehicle, the sensor quality of the vehicle, and the expertise of the user. Well-established and reputable vehicles with robust data collection processes generally inspire higher confidence.

A confidence level has a range from 0 to 1, with 1 representing the highest fidelity level and 0 representing the lowest fidelity level. The processor 133 may choose a high threshold value of confidence level, such as 0.8 or 0.9, when a large sample of reporting weather data are available in an interested area. Conversely, where a small sample of reporting weather data are available in an interested area, the processor 133 may choose a medium or low threshold value of confidence level, such as 0.5 or even below 0.5. The relevant size of sample data depends on the size of historical weather map data, number of the vehicles in the network, and the size of the interested area. A larger sample size provides a better representation of the weather conditions in the area, allowing for more accurate and reliable conclusions.

The processor 133 may determine the threshold value of the confidence level with a proper confidence interval to balance the sample size (namely the historical data size and vehicle size) and reliability. As an illustration, when using a standard distribution, a confidence level of 0.95 and a confidence interval of 0.05 (meaning that reliability between 0.90 and 1.00 is acceptable), a smaller sample size of 385 may suffice. However, a confidence level of 0.95 and a confidence interval of 0.01 (meaning that reliability between 0.94 and 0.96 is acceptable) may require a larger sample size of 9604. When making decisions of the threshold value of the confidence level, the processor 133 takes into account several factors such as statistical significance, risk of errors (confidence interval), precision and accuracy (confidence level), and impact on users of the vehicles 111 in the network 101 (as shown in FIG. 1). The threshold value is determined to strike a balance between having a high level of confidence and having enough data to draw meaningful conclusions when determining the threshold value for the confidence level.

Once the processor 133 has determined the threshold value of the confidence level of the weather data, the weather data may be selectively integrated into the real-time weather map 223. For high-fidelity weather data, the processor 133 may integrate the weather data into the weather map, without weighting the weather data. For low-fidelity weather data, the processor may decide to integrate or discard the low-fidelity weather data at a location. In embodiments, when the weather map contains the high-fidelity weather data at the location that reflects the real-time weather conditions, or the processor 133 receives a high-fidelity weather data at the same location, the low-fidelity weather data is discarded.

To handle low-fidelity weather data, the processor 133 has the option to either integrate or discard it at a specific location. If the weather map already contains high-fidelity data reflecting real-time weather conditions at that location or if the processor receives high-fidelity data for the same location, the low-fidelity data is discarded. For example, when no weather data or only limited weather data, such as outdated weather data, is available at the location, the processor 133 may integrate the low-fidelity data into the weather map. The processor 133 may integrate the low-fidelity data with a weight into the weather map. The weight may be proportional to the confidence level such that the historical weather data at the location may still carry its weight or when another low-fidelity weather data at the location is received, the weather data illustrated on the weather map reflects each input weather data's reliability.

After determining the confidence level and selective integration of the weather data, the processor 133 may determine the map visualization with weather variables of interest, such as temperature, wind direction/speed, pressure, humidity, snow, rain, or the like. The processor 133 may choose a mapping library or format, such as D3.js, Mapbox, or GIS, to plot the weather dot and customize the specific weather variables. The weather map may be a temperature map, a wind map, a pressure map, a humidity map, or a hybrid map with more than one weather variables. The processor 133 may choose different map visualization patterns for the weather map, such as a gradient map, a cluster map, a choropleth map, contour map, or a heatmap. For example, as illustrated in FIG. 2, the retrieved weather map 221 and real-time weather map 223 are cluster weather maps. The cluster maps use the same color or grey level to represent areas with identical or similar weather conditions, such as temperature. The newly input weather data at locations 251, 253, and 255 changes the center of the contour in the retrieved weather map 221. For example, based on the weather maps, the location of vehicle 213 in retrieved weather map 221 displays low weather data values below the lowest contour level. However, in real-time weather map 223 at location 253, there is a lifted value at the center of a contour. After the compiling of the real-time weather map 223, the real-time weather map is transmitted to the vehicles 111 of the network 101 via the out-of-network connection 151 or connections 121 (e.g. as illustrated in FIG. 1).

In some embodiments, the plotted weather data may be not uniformly distributed across the weather map. The processor 133 may interpolate the values of weather variables between weather data points to create a smooth gradient effect. The processor 133 may select one or more interpolation techniques, such as inverse distance weighting, kriging, or spline interpolation, to estimate values of weather variables at locations where weather data is not available.

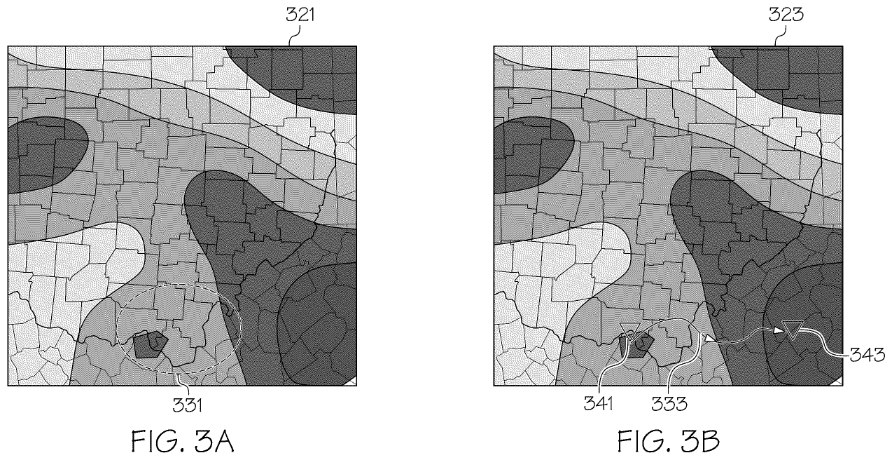

Referring to FIGS. 3A and 3B, example methods of generating a battery range of an electric vehicle based on a regular driving territory and on a route are illustrated. The one or more vehicles may include one or more electric vehicles, each with an estimated battery range indicating how far the vehicle may be driven with its remaining charge. The battery range of an electric vehicle may be affected by several factors, such as terrain and elevation changes, vehicle weight, battery age and conditions. Particularly, the performance and charging capability of the batteries of an electric vehicle may be detrimentally affected by temperature, especially at high or low temperatures. As such, the weather map, especially the temperature map, generated by the weather mapping system as disclosed herein can be used to estimate the battery range of an electric vehicle in terms of the temperature change within an interested area or route.

In embodiments, an electric vehicle of the network 101 (e.g. as illustrated in FIG. 1) may include a battery range module 542 (e.g. as illustrated in FIG. 6) to determine the battery range of the electric vehicle. The battery range module 542 may include a temperature-to-range model. The temperature-to-range model may be obtained by determining temperature ranges that have a significant impact on battery performance and gathering and analyzing the battery performance data of the electric vehicle under different temperature conditions. The temperature-to-range model may be pre-trained with battery performance data from manufacturers, research studies, or field tests. The battery range module 542 may also be trained to reflect the influence from other factors, such as the driving behavior of the user, terrain and elevation changes, vehicle weight, battery age and conditions.

The battery range module 542 (e.g. as illustrated in FIG. 6) then collects the temperature map data from the generated temperature map from the processor 133 and applies the temperature data to the battery range module to predict the battery range for a desired region or area. The user of the electric vehicle may select an area or a route for estimation. The battery range module 542 (e.g. as illustrated in FIG. 6) may also automatically select an area or a route to estimate the battery range.

As illustrated in FIG. 3A, in some embodiments, the battery range may be determined based on a regular driving territory 331 of a user of the electric vehicle and temperature data of the regular driving territory. In embodiments, the regular driving territory of a user of the electric vehicle may be determined by analyzing the GPS data collected during the user's driving, trip logs and mileage tracking of the user. For example, the GPS data may reveal frequently visited locations, routes taken, and patterns of movement.

The battery range module 542 may then extract the temperature data of the regular driving territory mapped from the temperature map 321 to estimate the battery range. In some embodiments, the battery range module 542 may determine an average temperature within the regular driving territory to determine the battery range. For the territory with large temperature variation, a temperature compensation model may be used to neutralize the influence of temperature fluctuation in estimating the battery range based on the average temperature in the territory. The battery range module 542 may collect actual battery usage data and predicted battery range and use a neural network to build the temperature compensation model.

As illustrated in FIG. 3B, in some other embodiments, the battery range may be determined based on a planned route 333 from point 341 to point 343 and temperature data along the planned route. The battery range module 542 determines the temperature profile along the planned route by mapping from the temperature map 323, and integrating the temperature profile with the planned driving distance to determine the battery range. The battery range module 542 may provide battery information such as an estimated remaining battery level after the route. When the planned route is beyond the estimated battery range, the electric vehicle may warn the user and further provide information on electric charging stations to the user.

After the battery range module 542 (e.g. as illustrated in FIG. 6), the electric vehicle may display the battery range on a screen 404 or a dashboard 406 (e.g. as illustrated in FIG. 5) on the electric vehicle or the user of the electric vehicle's smart devices. The information of the battery range may be a distance-based display, such as 100 miles or 150 kilometers, or an energy-based display, such as 50%, or 70%. When the user of the electric vehicle chooses multiple areas for estimation of the battery range, the electric vehicle may create a visual representation of the predicted battery range on the temperature map. The displayed map may overlay color-coded ranges onto the map, indicating the estimated range for each area based on temperature. The displayed map may use a gradient scale or discrete color intervals to represent different range levels.

Referring to FIG. 4, an interior view of an example vehicle 400 used in the weather mapping system is depicted. The vehicle may include a dashboard 406, a screen 404, and a speaker 402. The dashboard 406 may be a central panel located in front of the driver or the front passenger. The screen 404 may be a touchscreen. The vehicle may receive one or more weather maps generated in the weather mapping system 100 and display on the dashboard 406 or the screen 404, with various graphical representations of current weather conditions. It may include overlays for radar images, satellite imagery, temperature, precipitation, wind speed, and other relevant meteorological data. The weather map displayed on the screen 404 and dashboard 406 may be interactive, allowing the users of the vehicles to zoom in, pan, and customize the displayed information. The vehicle's audio system, which includes speakers 402 positioned throughout the cabin, may provide audio notifications and alerts for severe weather warnings. When a severe weather warning is received, such as thunderstorms, tornadoes, heavy rainfall, snowstorms, or other hazardous weather events, the speakers 402 may emit audible alarms or voice announcements to ensure the driver and passengers are informed about the potential dangers, and the screen 404 or dashboard 406 may display warning logos and details of the severe weather conditions. The dashboard 406 and the screen 404 may also display the charge distance when the vehicle is an electric vehicle.

In embodiments, the screen 404 and dashboard 406 may include a user interface. The user interface may allow the users of the vehicles 400 to interact with the weather map, zoom in/out, switch between different layers (e.g., temperature, precipitation, wind), and customize the display settings. The user interface may provide different color-coded overlay such that different weather parameters can be represented using color-coded overlays on the weather map, making it easier for the users to interpret the data at a glance. The weather map may be continuously updated in real-time. The vehicle 400 may include a function of alerts and notifications to issue alerts or notifications to the users based on predefined weather conditions, such as the severe weather conditions as disclosed above, or user-set thresholds.

Referring to FIG. 5, non-limiting components of the devices on the server 171 of the weather mapping system are depicted. The server 171 may comprise a confidence level module 522 and a compiling module 532. The server 171 may comprise various components, such as a memory 502, a processor 133, an input/output hardware 505, a network interface hardware 506, a data storage component 507, and a local interface 503.

The server 171 may be any device or combination of components comprising a processor 133 and a memory 502, such as a non-transitory computer readable memory. The processor 133 may be any device capable of executing the machine-readable instruction set stored in the non-transitory computer readable memory. Accordingly, the processor 133 may be an electric controller, an integrated circuit, a microchip, a computer, or any other computing device. The processor 133 may include any processing component(s) configured to receive and execute programming instructions (such as from the data storage component 507 and/or the memory component 502). The instructions may be in the form of a machine-readable instruction set stored in the data storage component 507 and/or the memory component 502. The processor 133 is communicatively coupled to the other components of the server 171 by the local interface 503. Accordingly, the local interface 503 may communicatively couple any number of processors 133 with one another, and allow the components coupled to the local interface 503 to operate in a distributed computing environment. The local interface 503 may be implemented as a bus or other interface to facilitate communication among the components of the server 171. In some embodiments, each of the components may operate as a node that may send and/or receive data. While the embodiment depicted in FIG. 5 includes a single processor, other embodiments may include more than one processor.

The memory 502 (e.g., a non-transitory computer-readable memory component) may comprise RAM, ROM, flash memories, hard drives, or any non-transitory memory device capable of storing machine-readable instructions such that the machine-readable instructions can be accessed and executed by the processor 133. The machine-readable instruction set may comprise logic or algorithm(s) written in any programming language of any generation (e.g., 1GL, 2GL, 3GL, 4GL, or 5GL) such as, for example, machine language that may be directly executed by the processor 133, or assembly language, object-oriented programming (OOP), scripting languages, microcode, etc., that may be compiled or assembled into machine readable instructions and stored in the memory 502. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 502 may be a machine-readable memory (which may also be referred to as a non-transitory processor-readable memory or medium) that stores instructions that, when executed by the processor 133, causes the processor 133 to perform a method or control scheme as described herein. While the embodiment depicted in FIG. 5 includes a single non-transitory computer-readable memory, other embodiments may include more than one memory module. The memory component 502 may include the confidence level module 522 and the compiling module 532.

The input/output hardware 505 may include a monitor, keyboard, mouse, printer, camera, microphone, speaker, and/or other device for receiving, sending, and/or presenting data. The network interface hardware 506 may include any wired or wireless networking hardware, such as a modem, LAN port, Wi-Fi card, WiMax card, mobile communications hardware, and/or other hardware for communicating with other networks and/or devices.

The data storage component 507 stores historical weather maps 527, historical vehicle confidence levels 537, and a network of vehicles 547. The historical weather maps 527 may include the weather maps generated by the processor 133 using the historical weather data received from the vehicles 111 of the network 101 (e.g. as illustrated in FIG. 1) or external weather data. The historical vehicle confidence levels 537 may include the confidence level of the weather data in association with the vehicles 111 of the network 101. The network of vehicles 547 may include the identification of the vehicles 111 of the network 101 and the connections 121 of the network 101 (e.g. as illustrated in FIG. 1).

Referring to FIG. 6, non-limiting components of the devices on the vehicle 111 of the weather mapping system. The vehicle 111 may comprise a confidence level module 522, a compiling module 532, and a battery range module 542. The vehicle 111 may comprise various components, such as a memory 512, a processor 133, an input/output hardware 515, a network interface hardware 516, a data storage component 517, a local interface 513, and sensors 533.

The vehicle 111 may include a controller that may be any device or combination of components comprising a processor 133 and a memory 512, such as a non-transitory computer readable memory. The processor 133 may be any device capable of executing the machine-readable instruction set stored in the non-transitory computer readable memory. Accordingly, the processor 133 may be an electric controller, an integrated circuit, a microchip, a computer, or any other computing device. The processor 133 may include any processing component(s) configured to receive and execute programming instructions (such as from the data storage component 517 and/or the memory component 512). The instructions may be in the form of a machine-readable instruction set stored in the data storage component 517 and/or the memory component 512. The processor 133 is communicatively coupled to the other components of the controller by the local interface 513. Accordingly, the local interface 513 may communicatively couple any number of processors 133 with one another, and allow the components coupled to the local interface 513 to operate in a distributed computing environment. The local interface 513 may be implemented as a bus or other interface to facilitate communication among the components of the vehicle 111. In some embodiments, each of the components may operate as a node that may send and/or receive data. While the embodiment depicted in FIG. 6 includes a single processor, other embodiments may include more than one processor.

The memory 512 and the input/output hardware 515 in the vehicle 111 in FIG. 6 may be similar to the memory 502 and the input/output hardware 505 in the server 171 as illustrated in FIG. 5. While the embodiment depicted in FIG. 6 includes a single non-transitory computer-readable memory, other embodiments may include more than one memory module.

The sensor 533 is coupled to the local interface 513 and communicatively coupled to the processor 133. The sensor 533 may be one or more sensors coupled to the vehicle 111 for determining the weather data and location data around the vehicle 111. The sensor 533 may include a proximity sensor, a camera, a radar, a thermometer, a barometer, a hygrometer, an anemometer, an ultrasonic sensor, a pyranometer, a compass, a location sensor, and other weather and location sensors.

The data storage component 517 stores historical weather maps 527, historical vehicle confidence levels 537, and a network of vehicles 547. The historical weather maps 527 may include the weather maps generated by the processor 133 using the historical weather data received from the vehicles 111 of the network 101 (e.g. as illustrated in FIG. 1) or external weather data. The historical vehicle confidence levels 537 may include the confidence level of the weather data in association with the vehicles 111 of the network 101. The network of vehicles 547 may include the identification of the vehicles 111 of the network 101 and the connections 121 of the network 101 (e.g. as illustrated in FIG. 1).

The memory component 512 may include the confidence level module 522, the compiling module 532, and the battery range module 542. The battery range module 542 may be trained and provided machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in a field of machine learning, for example, is a class of deep, feed-forward ANNs applied for audio analysis of the recordings. CNNs may be shift or space invariant and utilize shared-weight architecture and translation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including matters of logic with respect to the arrangement of steps, operational flow, order of components, or orientation of components; plain meaning derived from grammatical organization or punctuation, and; the number or type of embodiments described in the specification.

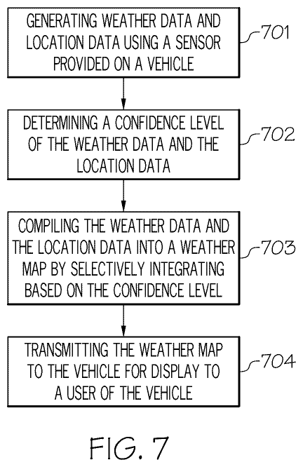

Referring to FIG. 7, an example flow diagram of illustrative steps for generating a weather map is illustrated. At block 701, the method may include a step of generating weather data and location data using a sensor provided on a vehicle. The sensor may be, without limitation, a proximity sensor, a camera, a radar, a thermometer, a barometer, a hygrometer, an anemometer, an ultrasonic sensor, a pyranometer, a compass, and/or a location sensor. At block 702, the method may include a step of determining a confidence level of the weather data and the location data.

At block 703, the method may include a step of compiling the weather data and the location data into a weather map by selectively integrating the weather data based on the confidence level of the weather data. In embodiments, the compiling step may include determining whether the confidence level of the weather data is beyond a threshold value. After determining the confidence level is beyond the threshold value, the compiling step may include integrating the weather data into the weather map. After determining the confidence level is not beyond the threshold value, the compiling step may include determining a location of the weather data and whether the weather map includes high-fidelity weather data at the location. After determining the weather map includes the high-fidelity weather data at the location, the compiling step may include discarding the weather data. After determining the weather map does not include the high-fidelity weather data at the location, the compiling step may include weighting the weather data based on the confidence level, and integrating the weighted weather data into the weather map.

At block 704, the method may include a step of transmitting the weather map to the vehicle for display to users of the vehicle. The transmitting step may further include determining whether a severe weather condition exists based on the weather data. After determining the severe weather condition exists, the transmitting step may include integrating the severe weather condition into the weather map, wherein the severe weather condition may include, without limitation, heavy rain, snowfall, freezing temperature, fog, a hailstorm, strong wind, a thunderstorm, flooding, freezing rain, and a tornado. The transmitting step may include notifying the user of the vehicle about the severe weather condition.

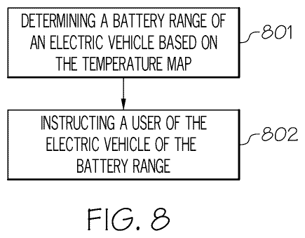

Referring to FIG. 8, an example flow diagram of illustrative steps for generating a charge range for an electric vehicle is illustrated. In the embodiments, the weather map may include a temperature map. At block 801, the method further comprises determining a battery range of an electric vehicle based on the temperature map. In some embodiments, the battery range may be determined based on a regular driving territory of the user of the electric vehicle and temperature data of the regular driving territory, wherein the temperature data of the regular driving territory is mapped from the temperature map. In other embodiments, the battery range is determined based on a planned route and temperature data along the planned route, wherein the temperature data along the planned route is mapped from the temperature map. At block 802, the method for generating a charge range may include a step of instructing a user of the electric vehicle of the battery range.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A system comprising
a vehicle;
a sensor provided on the vehicle, where the sensor is operable to generate weather data and location data; and
a processor programmed to compile the weather data and the location data into a weather map and transmit the weather map to the vehicle for display to a user of the vehicle.

2. The system of claim 1, wherein system further comprises an electric vehicle, and the weather map comprises a temperature map, wherein a battery range of the electric vehicle is determined based on the temperature map.

3. The system of claim 2, wherein the battery range is determined based on a regular driving territory of a user of the electric vehicle and temperature data of the regular driving territory, wherein the temperature data of the regular driving territory is mapped from the temperature map.

4. The system of claim 2, wherein the battery range is determined based on a planned route and temperature data along the planned route, wherein the temperature data along the planned route is mapped from the temperature map.

5. The system of claim 1, wherein the processor is operable to determine a confidence level of the weather data and the location data, and label the weather data as high-fidelity weather data when the confidence level is beyond a threshold value and as low-fidelity weather data when the confidence level is less than or equal to the threshold value.

6. The system of claim 5, wherein the processor is operable to integrate the high-fidelity weather data into the weather map.

7. The system of claim 5, wherein the processor is operable to:
discard the low-fidelity weather data at a location when the weather map contains the high-fidelity weather data at the location; and
weight the low-fidelity weather data based on the confidence level and integrate the weighted low-fidelity weather data into the weather map, when the weather map does not include the high-fidelity weather data at the location.

8. The system of claim 1, wherein the sensor is a proximity sensor, a camera, a radar, a thermometer, a barometer, a hygrometer, an anemometer, an ultrasonic sensor, a pyranometer, a compass, or a location sensor.

9. The system of claim 1, wherein the system is decentralized or centralized, and the system further comprises a server when the system is centralized.

10. The system of claim 9, wherein the server comprises the processor when the system is centralized or the vehicle comprises the processor when the system is decentralized.

11. The system of claim 1, wherein the weather map is a cluster map or a gradient map, and the weather map contains weather information of temperature, rain, fog, wind, or snow.

12. The system of claim 11, wherein the processor is programmed to:
determines whether a severe weather condition exists based on the weather data and the location data;
after determining the severe weather condition exists, integrates the severe weather condition into the weather map; and
wherein the severe weather condition is a heavy rain, a snowfall, a freezing temperature, fog, a hailstorm, a strong wind, a thunderstorm, flooding, a freezing rain, or a tornado.

13. A method comprising
generating weather data and location data using a sensor provided on a vehicle;
determining a confidence level of the weather data and the location data;
compiling the weather data and the location data into a weather map by selectively integrating the weather data based on the confidence level of the weather data; and
transmitting the weather map to the vehicle for display to a user of the vehicle.

14. The method of claim 13, wherein the weather data is selectively integrated into the weather map by
determining whether the confidence level of the weather data is beyond a threshold value;
after determining the confidence level is beyond the threshold value, integrating the weather data into the weather map;
after determining the confidence level is not beyond the threshold value, determining a location of the weather data and whether the weather map includes high-fidelity weather data at the location;
after determining the weather map includes the high-fidelity weather data at the location, discarding the weather data; and
after determining the weather map does not include the high-fidelity weather data at the location, weighting the weather data based on the confidence level, and integrating the weighted weather data into the weather map.

15. The method of claim 13, wherein the weather map comprising a temperature map, the method further comprises
determining a battery range of an electric vehicle based on the temperature map; and
instructing a user of the electric vehicle of the battery range.

16. The method of claim 15, wherein the battery range is determined based on a regular driving territory of the user of the electric vehicle and temperature data of the regular driving territory, wherein the temperature data of the regular driving territory is mapped from the temperature map.

17. The method of claim 15, wherein the battery range is determined based on a planned route and temperature data along the planned route, wherein the temperature data along the planned route is mapped from the temperature map.

18. The method of claim 13, wherein the method further comprises
determining whether a severe weather condition exists based on the weather data;
after determining the severe weather condition exists, integrating the severe weather condition into the weather map; and
notifying the user of the vehicle about the severe weather condition.

19. The method of claim 18, wherein the severe weather condition is heavy rain, snowfall, freezing temperature, fog, a hailstorm, strong wind, a thunderstorm, flooding, freezing rain, or a tornado.

20. The method of claim 13, wherein the sensor is a proximity sensor, a camera, a radar, a thermometer, a barometer, a hygrometer, an anemometer, an ultrasonic sensor, a pyranometer, a compass, or a location sensor.
